(19) United States
(12) Patent Application Publication
(10) Pub. No.: US 2017/0021735 A1
(43) Pub. Date: Jan. 26, 2017

(54) SYSTEM AND METHOD FOR CHARGING A PLURALITY OF ELECTRIC VEHICLES

(71) Applicant: ENVISION SOLAR INTERNATIONAL, INC., San Diego, CA (US)

(72) Inventors: Desmond Wheatley, Rancho Santa Fe, CA (US); Patrick Senatore, San Diego, CA (US)

(21) Appl. No.: 14/805,996

(22) Filed: Jul. 22, 2015

(51) Int. Cl. B60L 11/18

(52) U.S. Cl. CPC B60L 11/1816; B60L 11/1861

(57) ABSTRACT

A system and method for electrically charging a plurality of electric vehicles is operated continuously to charge the vehicles in repetitive cycles from a same power source. During the time of a charging cycle, T_{cycle}, (i.e. the sequence time needed to incrementally charge all vehicles connected to the power source), each vehicle is connected to the power source, in turn, for a same time duration, t_{d}. When completed, each cycle is then repeated. As vehicles are either connected or disconnected from the power source, the total time of the charging cycle, T_{cycle}, is respectively extended or shortened by t_{d}. Operationally, although T_{cycle} will vary as vehicles come and go, t_{d} remains constant.

### FIELD OF THE INVENTION

The present invention pertains to systems and methods for charging a plurality of electric vehicles from a same power source. More particularly, the present invention pertains to systems and methods for sequentially charging electric vehicles during successive charging cycles. The present invention is particularly, but not exclusively, useful as a system or method for providing an n number of charging stalls to sequentially charge an N number of vehicles during a charging cycle, when N is less than or equal to n.

### BACKGROUND OF THE INVENTION

Along with an increasing interest in the use of electricity for generating vehicular motive power, a consequent interest concerns how to provide the electrical power for this purpose. As is well known and appreciated, the task of electrically charging a vehicle takes time (e.g. several hours). Further, the actual time that is needed to efficiently charge a vehicle is dependent on several factors, such as power level and charging point availability. Moreover, the industry has now progressed to the point where operational and structural standards have been established for manufacturing components for use at a charging station. With all this in mind, the issue becomes how best to achieve maximum charging efficiency, within existing industry requirements, for as many electric vehicles as possible.

Range anxiety and charger availability are some of the biggest concerns for electric vehicle (EV) drivers. More abundant and available charging infrastructure is the best way to combat these concerns, but installing new complete stations can be expensive and difficult due to electrical grid or power supply limitations, installation costs, and permitting. Additionally, each EV charging station (EVCS) can only supply a finite amount of power through one, or at most, two standard outlets with current designs. Coupled with extended charge times, this means EVCS installations can quickly become unavailable in frequented charging areas.

SAE J1772 is an international standard that defines the physical design, communications protocol, and power requirements of the charging interface and controllers within an EV and an EVCS. The standard connector is called a coupler on the EVCS side and an inlet on the EV side. There are 5 electrical pins within each coupler: 2 power, 1 ground, and 2 control pins called a pilot and proximity. The pilot pin is the primary control connection that passes the required communication signal to enable, initialize, and monitor charging between an EV and an EVCS. The proximity pin is part of a separate control circuit within a coupler and an EV that informs the EV when a coupler is being connected or removed. Power requirements fall within two categories under the standard. Level 1 charging uses a 120 volt (V) alternating current (AC) circuit while Level 2 charging requires a 240V AC circuit. Both power levels can be supplied over the same coupler design and all existing Level 1 and Level 2 stations must follow this standard.

SAE J1772 also defines a standard combination coupler with extra pins to pass direct current (DC) at increased Level 1 and Level 2 rates. The DC charging sequence is controlled and monitored by a similar proximity and pilot methodology as the AC standard. CHAdeMO is a third standard for DC charging at high rates. The coupler and communications protocol are different from the SAE J1772 standard, but the overall process is similar.

With the above in mind, it is an object of the present invention to provide a system and method for increasing the available charging infrastructure for electric vehicles by adapting existing charging stations with a multi-coupler expansion adapter that will simultaneously accommodate a plurality of electric vehicles. Another object of the present invention is to provide a multi-coupler adapter for use with a single power source which sequentially charges a plurality of electric vehicles. Yet another object of the present invention is to provide a multi-coupler expansion adapter that is simple to use, is relatively easy to manufacture, and is comparatively cost effective.

### SUMMARY OF THE INVENTION

In accordance with the present invention, a multi-coupler expansion adapter is provided which will increase the available charging infrastructure for electric vehicles using the same charging station. Specifically, this is done by adapting existing charging stations so they can simultaneously accommodate a plurality of electric vehicles. In their combination, components of the present invention incorporate the multi-coupler expansion adapter to interconnect a single power source with a variable plurality of different electric vehicles (e.g. 6 or 8 vehicles).

For the methodology of the present invention, a time duration, t_{d}, is established during which each electric vehicle is individually charged. In this scheme, t_{d} remains constant and it is the same for each vehicle. Charging the plurality of vehicles that is connected into the system is then conducted continuously in a sequence of time durations, t_{d}. The sum total, Σt_{d}, results in an uninterrupted charging time cycle, T_{cycle}. According to the present invention, as the number of vehicles in the plurality is increased, or decreased, T_{cycle} will respectively increase or decrease by the increment/decrement t_{d}.

Components for the multi-coupler adapter of the present invention include, in combination, a controller, a sensor and a timer. In this combination, the controller is used for individually connecting a power source to each electric vehicle in the plurality of the electric vehicles. More specifically, as intended for the present invention, the controller gives the adapter a capability for individually connecting with an n number of different electric vehicles. For this capability, the sensor is used for identifying the N number of vehicles that are actually connected with the controller, at any one time. Thus, although N will fluctuate depending on the number of vehicles being charged, N will always be less than n+1. The timer that is included in the multi-coupler adapter is used for actuating the controller to sequence individual connections of time duration t_{d}, between the power source and the N number of electric vehicles.

With the above in mind, several important aspects of the invention deserve consideration. For one, T_{cycle}=Nt_{d}=Σt_{d}, and t_{d} will preferably be equal to approximately ten minutes. Further, as indicated above, N will fluctuate. Therefore, N will need to be reset with a decrement 1 whenever an electric vehicle has been charged and removed from the system. N will also need to reset with an increment 1 whenever an electric vehicle is initially connected into the system.

In accordance with regulatory requirements, the multi-coupler adapter will include a first power pin for providing power from the power source to charge the electric vehicle at a level 1 rate. The multi-coupler adapter will also include a second power pin for providing power from the power source to charge the electric vehicle at a level 2 rate. As envisioned for the present invention, charging at either of these rates will be accomplished in response to an operation of the controller. Further, the power level that is provided by the power source for charging an electric vehicle may be 120 volts alternating current (120V AC), 240 volts alternating current (240V AC) or a direct current voltage.

With the above in mind, a method for sequentially charging a plurality of electric vehicles in accordance with the present invention requires first setting up the system. In essence, this involves providing a power source which has been adapted to service an n number of charging stalls. Further, each of the charging stalls is configured to establish an appropriate individual power connection between the power source and the electric vehicle that is using the stall. In particular, this adaptation is accomplished by the multi-coupler adapter of the present invention.

Once the power source has been prepared for operation, the methodology of the present invention requires identifying the N number of vehicles that are actually connected with the controller of the multi-coupler adapter. Recall, N will be less than n+1. With N established, a sequence of connections is actuated between the power source and the N number of electric vehicles. In detail, this sequence extends during the time of an uninterrupted sequence cycle, T_{cycle}, and it is continuously repeated. Importantly, during each T_{cycle}, each electric vehicle is connected with the power source for a same time duration t_{d}.

As a sequence of cycles is repeated, it is anticipated that N will fluctuate. If so, N will be reset with a decrement 1 when an electric vehicle has been charged and removed from the system, and it will be reset with an increment 1 whenever an electric vehicle is initially connected into the system. Moreover, empty stalls in the sequence cycle will simply be bypassed.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a multi-vehicle charging station in accordance with the present invention;

FIG. 2 is a schematic of the operational components for a multi-coupler adapter in accordance with the present invention;

FIG. 3 is functional schematic of the multi-coupler adapter for use at a multi-vehicle charging station;

FIG. 4 is time diagram for the implementation of an uninterrupted charging sequence for the system of the present invention; and

FIG. 5 is a logic flow chart for task completion during an operation of the present invention.

### DESCRIPTION OF THE PREFERRED EMBODIMENTS

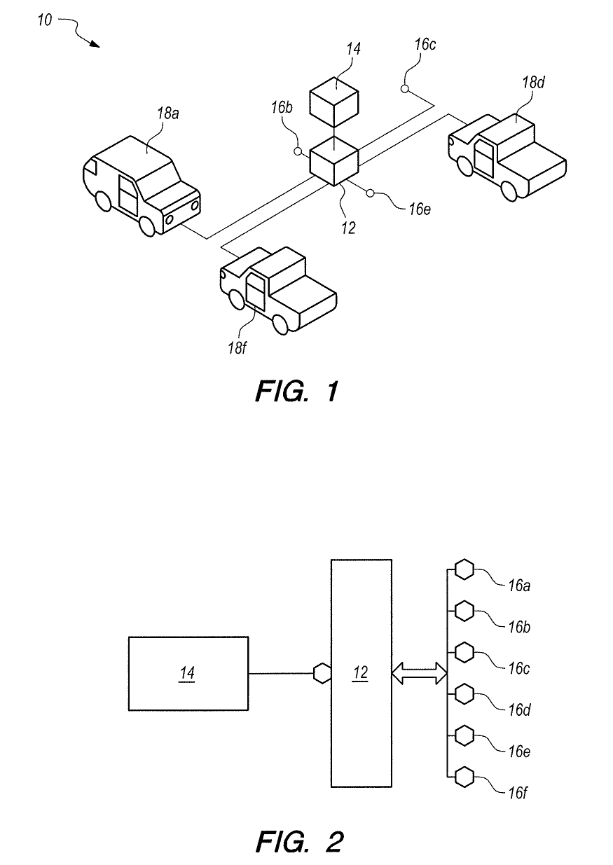

Referring initially to FIG. 1, a system for charging a plurality of electric vehicles in accordance with the present invention is shown, and is generally designated 10. As shown, the system 10 includes an adapter 12 that has the capability of interconnecting a single power source 14 with a plurality of different couplers 16. In turn, each coupler 16 in the plurality is capable of individually connecting the power source 14 with an electric vehicle 18.

In general, the system 10 will be capable of charging an n number of vehicles 18 during a defined time cycle, T_{cycle}. Typically, n will be six or eight. For disclosure purposes, however, the system 10 that is shown in FIG. 1 is considered as having the capability of servicing six different vehicles 18 (e.g. n=6). Accordingly, the system 10 will have six stalls that are hereinafter individually referenced by corresponding letters a-f. Using these notations, the coupler 16 for the “b” stall is hereinafter referred to as coupler 16b. Similarly, the electric vehicle 18 that occupies the “a” stall is hereinafter referred to as electric vehicle 18a. With this in mind, and as shown in FIG. 1, the system 10 is shown charging electric vehicles 18a, 18d and 18f, which are respectively connected with couplers 16a, 16d and 16f. The couplers 16a, 16d and 16f, however, are not shown in FIG. 1 because they are respectively coupled to the electric vehicles 18a, 18d and 18f. On the other hand, couplers 16b, 16c and 16e are shown because they are “not in use” (i.e. the couplers 16b, 16c and 16e are in vacant stalls “b”, “c” and “e”).

A schematic of the operational components for a multi-coupler adapter 12 of the present invention is shown in FIG. 2. As emphasized in FIG. 2, the adapter 12 interconnects a single power source 14 with a plurality of individual couplers 16 (e.g. couplers 16a-f). As envisioned for the system 10, the power source 14 will be capable of providing power at 120 volts alternating current (120V AC), 240 volts alternating current (240V AC) and/or with direct current voltage (DC).

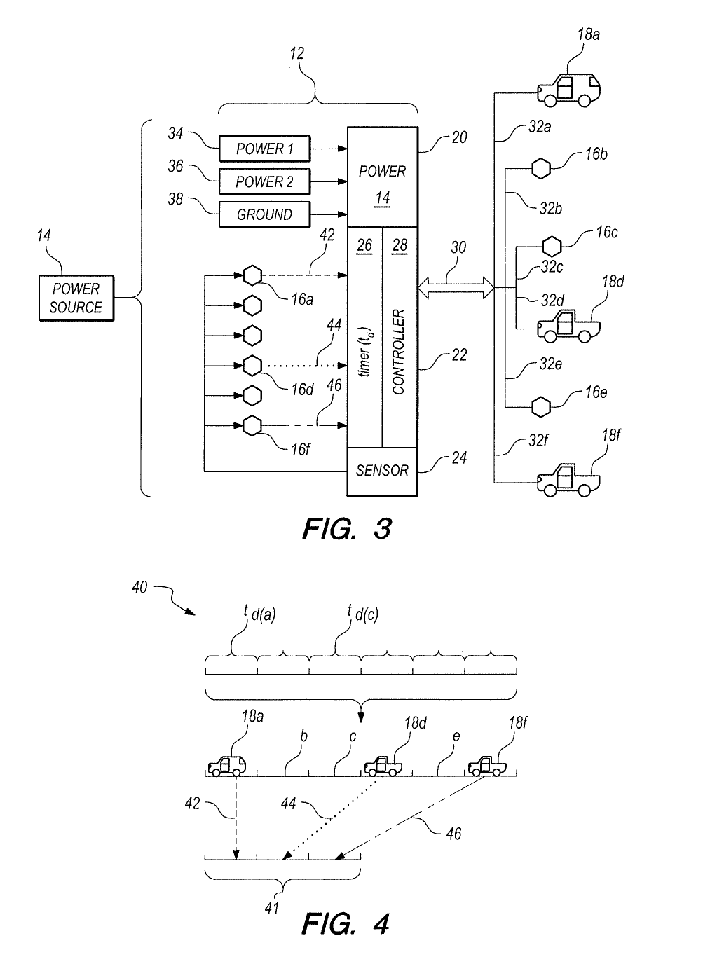

In detail, FIG. 3 shows that the adapter 12 includes, in combination, a power unit 20, a control unit 22 and a sensor 24. Further, the control unit 22 is shown to include a timer 26 and a controller 28. FIG. 3 also shows that the adapter 12 is joined to a connecting cable 30 which incorporates individual connecting lines 32a-f that each terminate at a respective plurality of couplers 16a-f.

Still referring to FIG. 3, it is to be appreciated that a multi-coupler adapter 12 in accordance with the present invention incorporates the five different pin connections that are needed to comply with regulatory requirements. These are: a first power pin 34, a second power pin 36, a ground pin 38, a pilot pin (not shown) for the control unit 22, and a proximity pin (not shown) for the sensor 24. Within this scheme, the first power pin 34 and the second power pin 36 can be established to provide the power levels noted above for charging the vehicles 18 (i.e. 120V AC, 240V AC, and DC).

Structurally, the controller 28 of the system 10 is used for individually connecting the power source 14 with each electric vehicle 18 in the plurality of possible electric vehicles 18a-f. As intended for the present invention, the adapter 12 has the capability for individually connecting with all of the n number of different electric vehicles 18 in the n different stalls (i.e. a-f), at the same time. As envisioned for the present invention, however, there will be times when some of the stalls a-f will be vacant. For this eventuality, the sensor 24 is provided to identify the N number of vehicles 18 that are actually connected with the controller 28 at any particular time. Thus, at any given time, N may be less than n, or it may be equal to N (i.e. 0<N≦n). Stated differently, however, N is always an integer less than n+1.

Within the adapter 12, the timer 26 is used to actuate the controller 28, and to thereby sequence connections between the power source 14 and the N number of electric vehicles 18. For the present invention, this sequencing is accomplished during the time of an uninterrupted sequence cycle, T_{cycle}. During this sequence cycle, T_{cycle}, each electric vehicle 18 is connected with the power source 14 for a same time duration t_{d}.

Referring now to FIG. 4, a full capacity time cycle, T_{cycle}, is shown and is generally designated 40. As shown the full capacity time cycle T_{cycle} 40 can accommodate all n (e.g. n=6) vehicles 18a-f, at the same time. Accordingly, in an uninterrupted sequence, T_{cycle} 40 will include all n number of time durations t_{d}, with only one time duration t_{d} being provided for each of the vehicles 18a-f. Note: for T_{cycle} 40, only the time durations t_{d(a)} and t_{d(c)} have been respectively identified for stalls “a” and “c”.

With reference to the example presented above for vehicles 18a, 18d, and 18f, N=3. Further, FIG. 4 indicates that only respective time durations t_{d(a)}, t_{d(d)}, and t_{d(f)} are assigned to the exemplary time cycle T_{cycle} 41. Importantly, t_{d(b}), t_{d(c)}, and t_{d(e)} have been bypassed and are not been included because the “b”, “c” and “e” stalls are vacant (empty). During this exemplary time cycle T_{cycle} 41, the following conditions are recognized:
N=3 to establish T_{cycle}=3t_{d};
Sensor 24 identifies that electric vehicle 18a in stall “a” is connected to system 10;
Controller 28 connects with electric vehicle 18a via connecting line 32a;
Electric vehicle 18a is charged from power source 14 for a time duration t_{d(a)}, represented by the dashed line 42;
Advance, in sequence, to the next occupied stall (i.e. stall “d”);
Sensor 24 identifies that electric vehicle 18d in stall “d” is connected to system 10;
Controller 28 connects with electric vehicle 18d via connecting line 32d;
Electric vehicle 18a is charged from power source 14 for a time duration t_{d(d)}, represented by the dotted line 44;
Advance, in sequence, to the next occupied stall (i.e. stall “f”);
Sensor 24 identifies that electric vehicle 18f in stall “f” is connected to system 10;
Controller 28 connects with electric vehicle 18f via connecting line 32f;
Electric vehicle 18f is charged from power source 14 for a time duration t_{d(f)}, represented by the dot-dash line 46; and
Reset N, if necessary and repeat T_{cycle}.

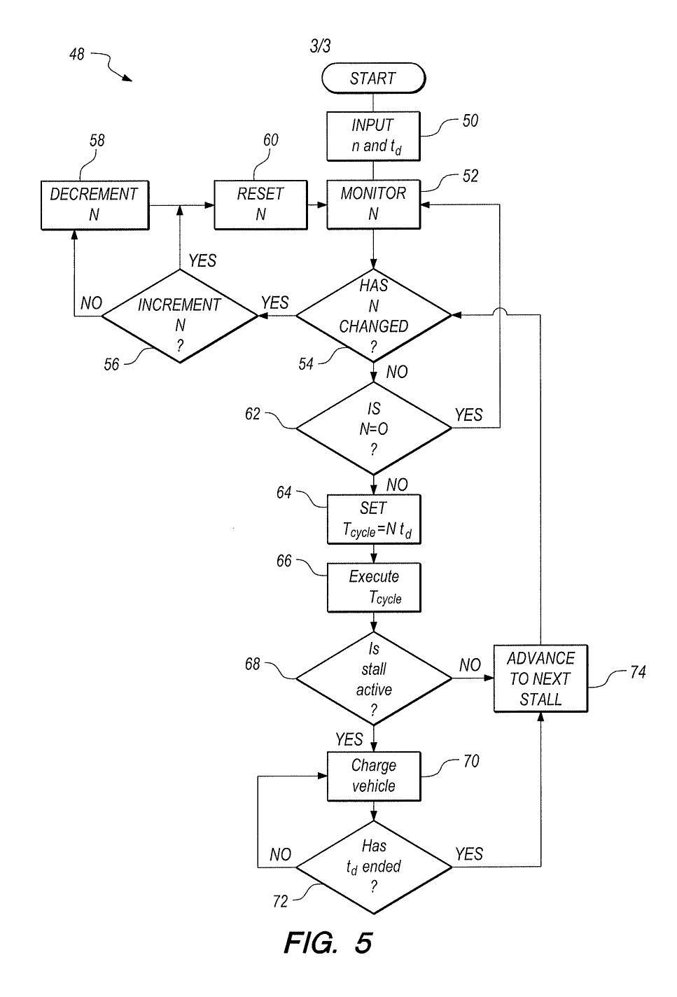

The essential tasks to be performed during an operation of the system 10 are presented in their interactive sequencing in the logic flow chart 48 shown in FIG. 5. Referring to the action block 50 in flow chart 48, it will be appreciated that an initial set-up for the system 10 requires inputting the number n, which is the number of vehicle stalls provided for the system 10, and also inputting the time duration, t_{d}, that is to be used for charging each vehicle during a charging cycle. Preferably, t_{d} will be set for approximately ten minutes. After n and t_{d} have been input, action block 52 indicates that the system 10 monitors N, the actual number of vehicles 18 that are connected into the system 10.

When collectively considering the inquiry blocks 54 and 56 together with the action blocks 58 and 60 in flow chart 48, it will be further appreciated that the system 10 has the capability of adjusting its configuration, depending on changes in N. Specifically, as N changes, it can be appropriately incremented whenever an additional electric vehicle 18 is connected into the system 10, or it can be decremented whenever an electric vehicle 18 is disconnected and removed from the system 10. In any event, the inquiry block 62 requires at least one electric vehicle 18 be connected into the system 10 before proceeding with a charging operation.

Whenever N≧1, and with any changes in N being accounted for, the action block 64 requires that T_{cycle} be calculated. As previously disclosed elsewhere herein, this calculation is accomplished by setting T_{cycle}=Nt_{d}. This being done, action block 66 indicates that T_{cycle} is to be executed. At this point it is noteworthy to recall that T_{cycle} operates continuously. In particular, T_{cycle} is uninterrupted and bypasses empty stalls as long as N≧1. Moreover, it is continuously repeated until N=0.

During an operation of the system 10, inquiry block 68, action block 70 and inquiry block 72, collectively indicate that as T_{cycle} is being executed the electric vehicle 18 in a particular active stall (e.g. electric vehicle 18f considered above) will be charged during a time duration t_{d}. Thereafter, action block 74 indicates that T_{cycle} is sequentially advanced to the next stall. On the other hand, whenever a particular stall a-f is empty, inquiry block 68 and action block 74, together, indicate that the empty stall will be bypassed.

While the particular System and Method for Charging a Plurality of Electric Vehicles as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A multi-coupler adapter for use with a power source to selectively charge a plurality of electric vehicles, the adapter comprising:
a controller for individually connecting the power source with an electric vehicle in the plurality of electric vehicles, wherein the adapter has a capability for individually connecting with an n number of different electric vehicles;
a sensor for identifying an N number of vehicles connected with the controller, wherein N is less than n+1; and
a timer for actuating the controller to sequence connections between the power source and the N number of electric vehicles during the time of an uninterrupted sequence cycle, T_{cycle}, wherein each electric vehicle is connected with the power source for a same time duration t_{d} during the sequence cycle T_{cycle}.

2. An adapter as recited in claim 1 wherein T_{cycle}=Nt_{d}.

3. An adapter as recited in claim 1 wherein t_{d}=ten minutes.

4. An adapter as recited in claim 1 wherein N is reset with a decrement 1 when an electric vehicle has been charged, and wherein N is reset with an increment 1 when an electric vehicle enters the plurality of electric vehicles.

5. An adapter as recited in claim 1 further comprising:
a first power pin for providing power from the power source to charge the electric vehicle at a level 1 rate in response to an operation of the controller; and
a second power pin for providing power from the power source to charge the electric vehicle at a level 2 rate in response to an operation of the controller.

6. An adapter as recited in claim 1 wherein a power level provided by the power source for charging an electric vehicle is selected from the group consisting of 120 volts alternating current (120V AC), 240 volts alternating current (240V AC) and a direct current voltage.

7. An adapter as recited in claim 1 wherein n=6.

8. A system for simultaneously charging a plurality of electric vehicles which comprises:
an electrical power source;
an adapter for establishing a plurality of power connections, wherein each power connection interconnects the power source with an electric vehicle in the plurality, to charge the electric vehicle; and
a control unit mounted on the adapter for selectively establishing each power connection sequentially in accordance with a predetermined protocol.

9. A system as recited in claim 8 wherein the adapter has the capability for individually connecting with an n number of different vehicles, and for identifying an N number of active power connections with the vehicles at any given time, wherein N is less than n+1.

10. A system as recited in claim 9 wherein the control unit includes, in combination, a timer and a controller to sequence connections between the power source and the N number of electric vehicles during the time of an uninterrupted sequence cycle, T_{cycle}, wherein each electric vehicle is connected with the power source for a same time duration t_{d} during the sequence cycle T_{cycle}.

11. A system as recited in claim 10 wherein T_{cycle}=Nt_{d}.

12. A system as recited in claim 9 wherein N is reset with a decrement 1 when an electric vehicle has been charged, and wherein N is reset with an increment 1 when an electric vehicle enters the plurality of electric vehicles.

13. A system as recited in claim 8 wherein a power level provided by the power source for charging an electric vehicle is selected from the group consisting of 120 volts alternating current (120V AC), 240 volts alternating current (240V AC) and a direct current voltage.

14. A method for sequentially charging a plurality of electric vehicles, which comprises the steps of:
providing a power source;
establishing an n number of charging stalls, wherein each charging stall is configured to establish a power connection for one electric vehicle with the power source;
identifying an N number of vehicles connected with the controller, wherein N is less than n+1; and
actuating a sequence of connections between the power source and the N number of electric vehicles during the time of an uninterrupted sequence cycle, T_{cycle}, wherein each electric vehicle is connected with the power source for a same time duration t_{d} during the sequence cycle T_{cycle}.

15. A method as recited in claim 14 further comprising the steps of:
decrementing N when an electric vehicle has been charged; and
incrementing N when an electric vehicle enters the plurality of electric vehicles.

16. A method as recited in claim 14 further comprising the step of bypassing empty stalls in the sequence cycle.

17. A method as recited in claim 14 wherein T_{cycle}=Nt_{d}.

18. A method as recited in claim 14 wherein t_{d}=ten minutes.

19. A method as recited in claim 14 wherein a power level provided by the power source for charging an electric vehicle is selected from the group consisting of 120 volts alternating current (120V AC), 240 volts alternating current (240V AC) and a direct current voltage.

20. A method as recited in claim 14 wherein n=6.
